(19) United States
(12) Patent Application Publication
(10) Pub. No.: US 2012/0182742 A1
(43) Pub. Date: Jul. 19, 2012

(54) REPLACEABLE LED LAMP

(76) Inventor: PO-SHENG HUANG, Zhongli City (TW)

(21) Appl. No.: 13/006,532

(22) Filed: Jan. 14, 2011

(51) Int. Cl. F21V 7/00

(52) U.S. Cl. 362/310

(57) ABSTRACT

A replaceable LED lamp includes a base and a plurality of lamp cups coupled to the base. The lamp cup comprises a lighting member as a light source. Each lamp cup can be separately detached for replacement to save maintenance cost and to enhance the heat dissipation function and to shorten the working time.

### BACKGROUND OF THE INVENTION

1. Field of the Invention

The present invention relates to a replaceable LED lamp, and more particularly, to a lamp having a plurality of lamp cups which can be separately detached for replacement.

2. Description of the Prior Art

LED has a high efficiency to transform electric energy into light energy, which saves electricity, is compact and durable, has a long service life and can be deemed the best lighting source in this century.

A conventional large-sized LED lamp comprises a plurality of LED light bulbs which are welded to a base. It is inconvenient to maintain the LED light bulbs and consumes time. Because all the LED light bulbs are connected to one base, it is also inconvenient to weld the light bulbs outdoors. Once one or two LED light bulbs are damaged, it is required to take out the whole base for maintenance. This consumes labor and time. Accordingly, the inventor of the present invention has devoted himself based on his many years of practical experiences to solve this problem.

### SUMMARY OF THE INVENTION

The primary object of the present invention is to provide a lamp for replacing a LED light bulb easily.

In order to achieve to the aforesaid object, there is provided with a replaceable LED lamp. The lamp comprises a base and at least one lamp cup. The base has at least one lock hole thereon. The lock hole corresponds in position to the lamp cup. The lamp cup comprises a lighting member therein. The lighting member comprises a plurality of LED luminous chips.

In case one luminous chip is damaged, only the relative lamp cup is detached to replace with a new one. This is a quick and convenient way to maintain the lamp. Besides, the base can be designed to have an arc surface for changing the emitting angle of the light from each lamp cup. The present invention provides a better illumination for the demand of different occasions.

### BRIEF DESCRIPTION OF THE DRAWINGS

FIG. 1 is an exploded view according to a preferred embodiment of the present invention;

FIG. 2 is an exploded view of a lamp cup according to the preferred embodiment of the present invention; and

FIG. 3 is a schematic of the preferred embodiment of the present invention when in use.

### DETAILED DESCRIPTION OF THE PREFERRED EMBODIMENTS

Embodiments of the present invention will now be described, by way of example only, with reference to the accompanying drawings.

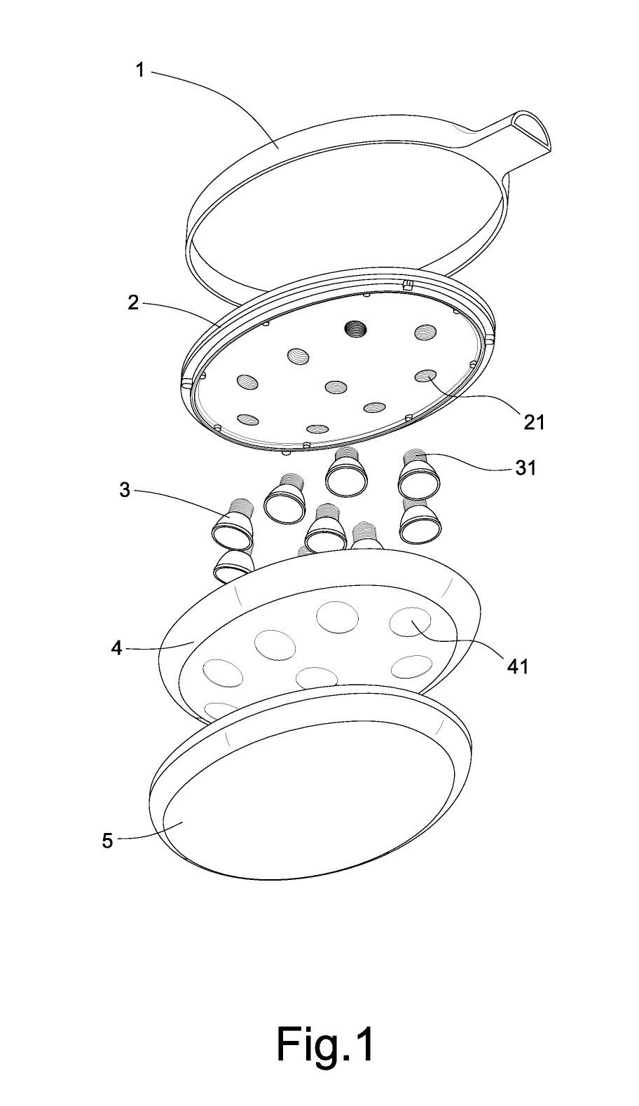

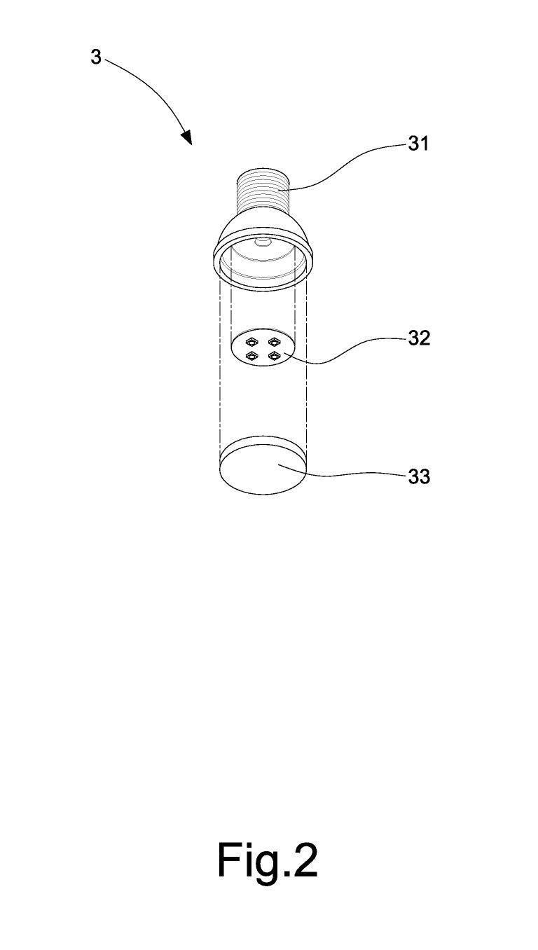

As shown in FIG. 1 and FIG. 2, a replaceable LED (light emitting diode) lamp according to a preferred embodiment of the present invention comprises an outer cover 1, a base 2, at least one lamp cup 3, an inner cover 4, and a lampshade 5.

The outer cover 1 is a lamp housing to accommodate other parts.

The base 2 is a panel disposed at an inner side of the outer cover 1. The base 2 has at least one lock hole 21 on an outer side thereof. The lock hole 21 has threads on an inner wall thereof.

The lamp cup 3 is a luminous unit. One end of the lamp cup 3 has a lamp head 31 connected to the lock hole 21. Another opposing end of the lamp cup 3 is in a bowl shape with an inner concave to reflect light. The opposing end of the lamp cup 3 is provided with a lighting member 32 and covered with a light-pervious plate 33, as shown in FIG. 2. The lighting member 32 is a LED chip or a LED light bulb.

The inner cover 4 is a housing having a plurality of through holes 41. The inner cover 4 is coupled to the outer cover 1 to cover the base 2 and the light cup 3. The through hole 41 corresponds in position to the lamp cup 3, so that the light can be emitted through the through hole 41.

The lampshade 5 is made of a light-pervious material. The lampshade 5 is coupled to the outer cover 1 to cover the base 2, the light cup 3 and the inner cover 4. The light of the lamp cup 3 passes through the lampshade 5.

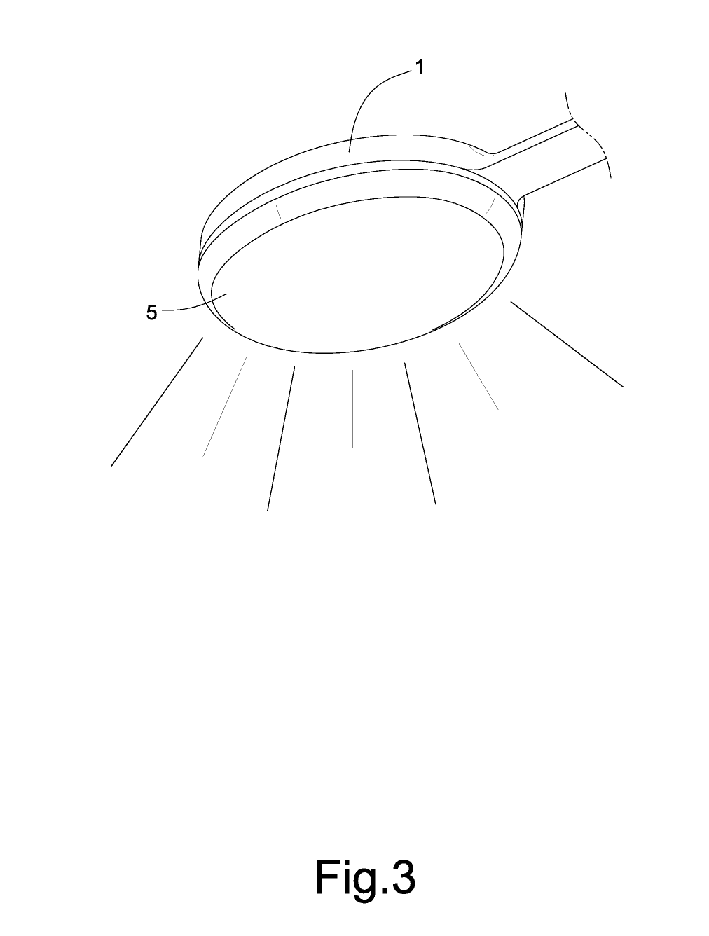

Referring to FIG. 3, the lamp of the present invention is used as a street lamp. When supplied with electric power, the light of the lamp cup 3 passes the through hole 41 and the lampshade 5 to emit even and bright light. The lighting member 32 made of LED chip or LED light bulb provides an energy-saving effect. When the lighting member 32 of one lamp cup 3 malfunctions or is damaged, the lampshade 5 and the inner cover 4 can be disassembled to replace with a new one and then assembled again. It is simple and quick to maintain the lamp.

The lamp head 31 and the lock hole 21 have threads.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A replaceable light emitting diode (LED) lamp, comprising:
a base, the base having at least one lock hole thereon; and
at least one lamp cup, the lamp cup comprising a lighting member therein, one end of the lamp cup having a lamp head, the lamp head being coupled to the lock hole of the base.

2. The replaceable LED lamp as claimed in claim 1, further comprising an inner cover disposed at an outer edge of the lamp cup after the base is connected with the lamp cup.

3. The replaceable LED lamp as claimed in claim 2, wherein the inner cover is a housing having a through hole, and the through hole corresponds in position to the lamp cup.

4. The replaceable LED lamp as claimed in claim 3, further comprising an outer cover coupled to an outer edge of the base and a lampshade coupled to an outer edge of the inner cover.

5. The replaceable LED lamp as claimed in claim 1, wherein another opposing end of the lamp cup is in a bowl shape with an inner concave to reflect light, and the opposing end of the lamp cup is provided with the lighting member and covered with a light-pervious plate.

6. The replaceable LED lamp as claimed in claim 1, wherein the lighting member is a LED chip.

7. The replaceable LED lamp as claimed in claim 4, wherein the lampshade is made of a light-pervious material, the lampshade is coupled to the outer cover to cover the base, the light cup and the inner cover, and the light of the lamp cup passes through the lampshade.
